(19) United States
(12) Patent Application Publication
(10) Pub. No.: US 2019/0207954 A1
(43) Pub. Date: Jul. 4, 2019

(54) SYSTEMS AND METHODS FOR EVALUATING ENCRYPTED DATA PACKETS IN A NETWORKED ENVIRONMENT

(71) Applicant: ShieldX Networks, Inc., San Jose, CA (US)

(72) Inventors: Ratinder Paul Singh Ahuja, Saratoga, CA (US); Manuel Nedbal, Santa Clara, CA (US); Sumanth Gangashanaiah, Cupertino, CA (US); Xiaodong Ye, Los Gatos, CA (US)

(21) Appl. No.: 15/860,303

(22) Filed: Jan. 2, 2018

(51) Int. Cl. H04L 29/06

(52) U.S. Cl. CPC H04L 63/1416; H04L 63/20; H04L 63/166; H04L 63/0428; H04L 63/0236

(57) ABSTRACT

Systems, methods, and apparatuses enable evaluating encrypted or obfuscated data packets being transmitted over a connection in a networked environment. In an embodiment, a security service utilizes one or more microservices operating as detectors to analyze characteristics of an encrypted or obfuscated network connection. Using the information from the detectors, the security service classifies the type of encryption protocol used on an encrypted connection and determines an extrapolated protocol state. Using the extrapolated protocol state with additional information received from the detectors, the security service determines a risk level associated with the connection and executes security actions on the connection based on the risk level.

### TECHNICAL FIELD

Embodiments described herein generally relate to network security. In particular, embodiments described herein generally relate to systems and methods for evaluating encrypted or obfuscated data packets sent between devices in a network environment.

### BACKGROUND INFORMATION

A majority of businesses and other organizations rely on computer systems and networks for an increasingly wide variety of business operations. As reliance on computing technologies has grown, so too has the importance of securing computer systems and networks against internal and external security threats. However, the breadth and complexity of security threats targeting such computer systems and networks is far and wide and ever growing. To monitor and address these security threats, organizations increasingly rely on sophisticated computer security applications and hardware such as firewalls, anti-virus tools, data loss prevention (DLP) software, etc.

Encryption is a common means of securely protecting data, particularly sensitive data that is to be transmitted over network connections. Each encryption protocol may encrypt data in different ways. Typical encryption protocols encrypt and decrypt data using key pairs. Once data has been encrypted using a first key of the key pair, it can only be decrypted using the corresponding second key in the key pair. This ensures that the data, even if intercepted during transmission by a malicious actor, cannot be decrypted without the second key.

### BRIEF DESCRIPTION OF THE DRAWINGS

The various advantages of the embodiments disclosed herein will become apparent to one skilled in the art by reading the following specification and appended claims, and by referencing the drawings, in which:

FIG. 1 is a block diagram illustrating computer hardware, including a memory and processor, in accordance with the disclosed embodiments;

FIG. 2 illustrates a scalable security architecture implementing a three-time scale out using security microservices in accordance with the disclosed embodiments;

FIG. 3 illustrates an arbitrary scaling out of a microservice in accordance with the disclosed embodiments;

FIG. 4 is a block diagram illustrating a security service configured to monitor traffic sent among an application and one or more servers through a routing network in accordance with the disclosed embodiments;

FIG. 5 is a block flow diagram illustrating application data traversing to a server after passing through a hierarchy of security microservices in accordance with the disclosed embodiments;

FIG. 6 is a flow of application data through a stateless processing, fault-tolerant microservice environment in accordance with the disclosed embodiments;

FIG. 7 is a block diagram illustrating a security service in accordance with the disclosed embodiments;

FIG. 8 is a block diagram illustrating a protocol extrapolation microservice in accordance with the disclosed embodiments;

FIG. 9 is a block diagram illustrating an extrapolation state record in accordance with the disclosed embodiments;

FIG. 10 is a flow diagram illustrating a process for determining an extrapolated protocol state for an encrypted or obfuscated protocol in accordance with an embodiment;

FIG. 11 is a flow diagram illustrating a process for executing a security action based on updating a risk level in accordance with an embodiment; and

FIG. 12 is a block diagram that illustrates a computer system utilized in implementing the above-described techniques in accordance with some of the disclosed embodiments.

### DETAILED DESCRIPTION

In the following description, numerous specific details are set forth. However, it is understood that embodiments of the disclosure may be practiced without these specific details. In other instances, well-known circuits, structures and techniques have not been shown in detail to not obscure the understanding of this description.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

When a security system operates in-line with secure protocols (e.g., SSL, SSH, etc.), the security system typically has knowledge of the encryption protocols used for data packets. In one embodiment, data packets include messages and other data being transferred between devices, packets at the IP and TCP layer, and messages transported over multiple IP/TCP packets for upper layer protocols like SSL (e.g., an SSL message comprising 1 to n TCP packets). However, deficiencies of existing security solutions become apparent when the security system is not in-line with the secure protocols and/or when the security system does not have the ability to understand a particular encryption protocol. For example, security systems operating as a man-in-the-middle may apply a security policy to the content of an SSL connection between devices when configured to intercept the packets to and from each device but be unable to do so when configured to passively monitor the packets between the same devices. Certain secure protocols (including SSL) have the ability to provide detection of a man-in-the-middle and only allow communication that prevents packet intercept. In such situations, the security system is unable to decrypt the data packets or be able to understand the contents of the data packets. As a result, the security system may be unable to sufficiently secure the system from attacks or malicious content.

To address the deficiencies of existing security infrastructures, embodiments detailed herein use information obtained from detectors in order to characterize the protocols used on data packets intercepted or received by the security system. The ability to characterize the protocols allows the security system to perform certain security actions even when data packets are encrypted or obfuscated. In general, any protocol which is not understood or documented can be thought of as obfuscated from the point of view of a security system. Encrypted content can be generally recognized through statistical means (including methods such as observing the histogram of bytes or byte sequences). Some protocols, such as SSL, include unencrypted protocol headers while encrypting only transported data.

For example, some embodiments detailed herein utilize one or more detectors to monitor a connection and analyze characteristics of the connection. In some embodiments, the connection is encrypted or otherwise obfuscated. In some embodiments, a security service receives an initialization detection from an initialization detector and determines a classification type for an encryption protocol used on the encrypted connection. A protocol identification and an extrapolated protocol state are determined for the encryption protocol. In some embodiment, the security service determines the extrapolated protocol state using information received from the one or more detectors. Subsequently, additional information is received from additional detections made by the one or detectors, and the additional information is used to update the extrapolated protocol state. In some embodiments, in response to updating the extrapolated protocol state, a security service executes a security action on the encrypted connection.

In some embodiments, a security service receives an activity detection from a detector configured to monitor data traffic transmitted over a connection. In some embodiments, the connection is an encrypted connection that is encrypted using an encryption protocol. A risk level associated with the connection is determined. The risk level associated with the connection is updated based on a new activity detection and an extrapolated protocol state associated with the connection. In some embodiment, the risk level associated with the connection is increased in response to determining that an activity event indicated in the new activity detection is anomalous. In some embodiments, a security service executes a security action on the connection based on the updated risk level. In some embodiments, executing the security action includes performing one or more of: blocking data traffic on the connection, quarantining the data traffic, and transmitting an alert message.

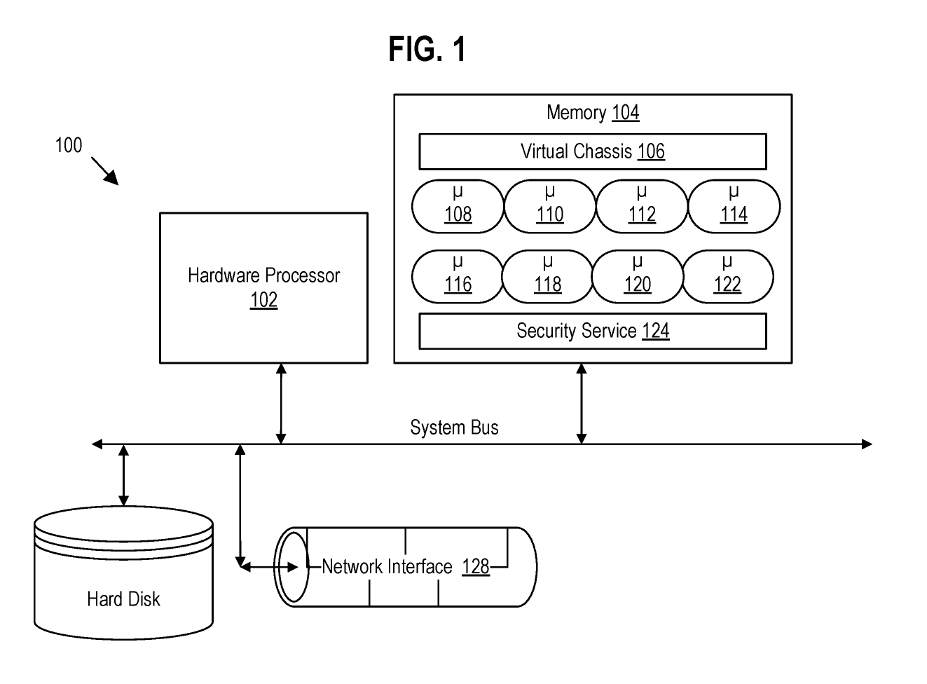

FIG. 1 is a block diagram 100 illustrating computer hardware, including a memory and processor, in accordance with the disclosed embodiments. Network security microservices 108-122 are stored in memory 104 (e.g., volatile memory such as Random Access Memory (RAM) and/or non-volatile memory such as disk) and executed by one or more hardware processors or processor cores 102. Network security microservices 108-122, consisting of computer-executable instructions to perform one or more specific security services, are deployed based on configuration across available physical servers. Typically, each microservice receives a configuration and tasks via a backplane of a virtual chassis 106, and returns status, statistics, and other information to the backplane.

The data processed by the network security system 100 is transferred from a microservice to another (higher hierarchy) microservice using a data plane. In some embodiments, during such a transfer, a lower microservice decides (based on configuration, current statistics, and other information) as to which next microservice to utilize. Such a decision may constitute a load-balancing decision to assure that the higher-hierarchy microservices are efficiently utilized. In other embodiments, the decision of which microservice to utilize is made by a more central entity.

As illustrated, a network security system 100 utilizes a hardware processor 102 (such as a central processing unit (CPU) or one or more cores thereof, a graphics processing unit (GPU) or one or more cores thereof, or an accelerated processing unit (APU) or one or more cores thereof) to execute microservices and other applications (e.g., virtual chassis 106, security service 124, etc.) stored in memory 104. A network interface 128 (e.g., fabric or interconnect that is wired or wireless) provides a means for communicating with a data center. Network security system 100 may inspect traffic, detect threats, generate security policies (e.g., access control lists), and otherwise protects a data center using the microservices 108-122.

Embodiments of a network security system 100 providing the above capabilities are now discussed in more detail. Network security system 100 adds security to, or enhances the security of, a datacenter or other computing environment. In an embodiment, network security system 100 is delivered (e.g., downloaded) in the form of a seed software application. The seed software application instantiates microservices of the network security system on a host in the datacenter. As used herein, a microservice container refers to where the microservice runs, for example, on a virtual machine. Once deployed, network security system 100 utilizes a hardware processor 102, memory 104, and network interface 128. In many scenarios, security can be added/configured using existing hardware and/or without purchasing additional rack devices for particular functionality. The seed software application may be installed on any one of a wide variety of hosts—be they slow or fast, low-cost or high-cost, commodity or customized, geographically dispersed, part of a redundancy scheme, or part of a system with regular back-ups.

In some embodiments, a network security system 100 utilizes a network interface 128 to explore the datacenter and to discover existing network segments, determine security settings to apply to various network segments, detect available hosts and hardware resources, and determine additional configuration information as needed. In an embodiment, the datacenter itself includes several machines with hypervisors, or physical hardware, and the network security system 100 offers microservices to communicate with and protect one or more of those internal virtual machines or physical hardware. Based on performing datacenter discovery, a network security system 100, in some embodiments, may then offer or suggest available security tools for selection either through a graphical interface or via connections with existing enterprise management software. In one embodiment, once configured, a network security system 100 is deployed “in-line,” receiving packets headed for the datacenter, thereby allowing network security system to intercept and block suspicious traffic before it reaches the datacenter. With an understanding of the datacenter, a network security system 100 deploys microservices to inspect traffic throughout the datacenter, and not only at ingress. In some embodiments, a network security system 100 is deployed in a “copy only” configuration, in which the system monitors traffic, detects threats, and generates alerts, but does not intercept traffic before it arrives at the datacenter.

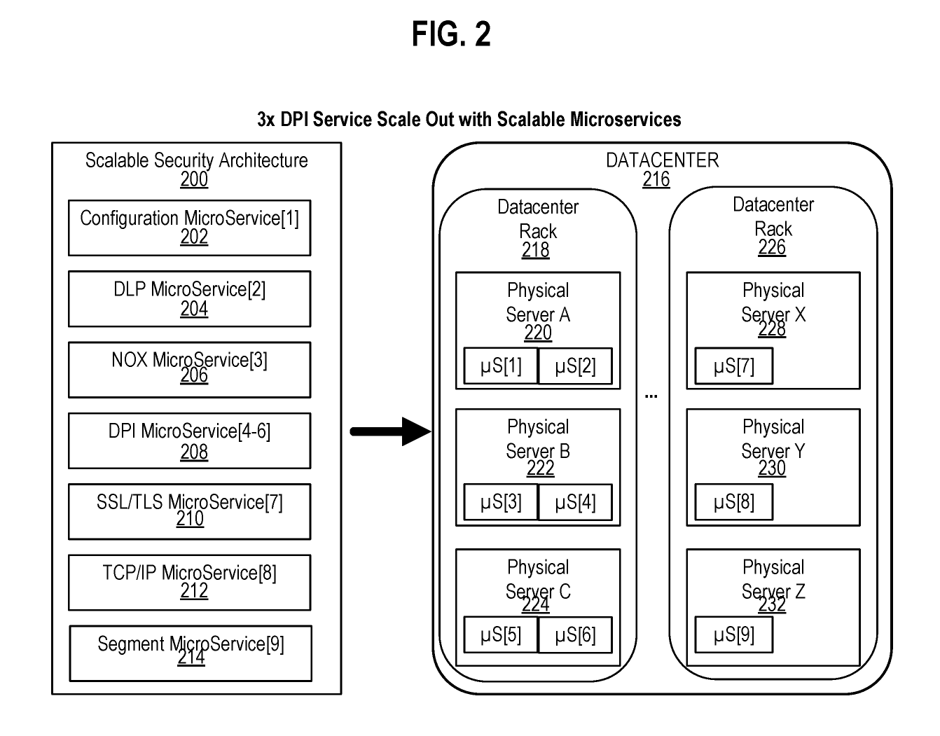

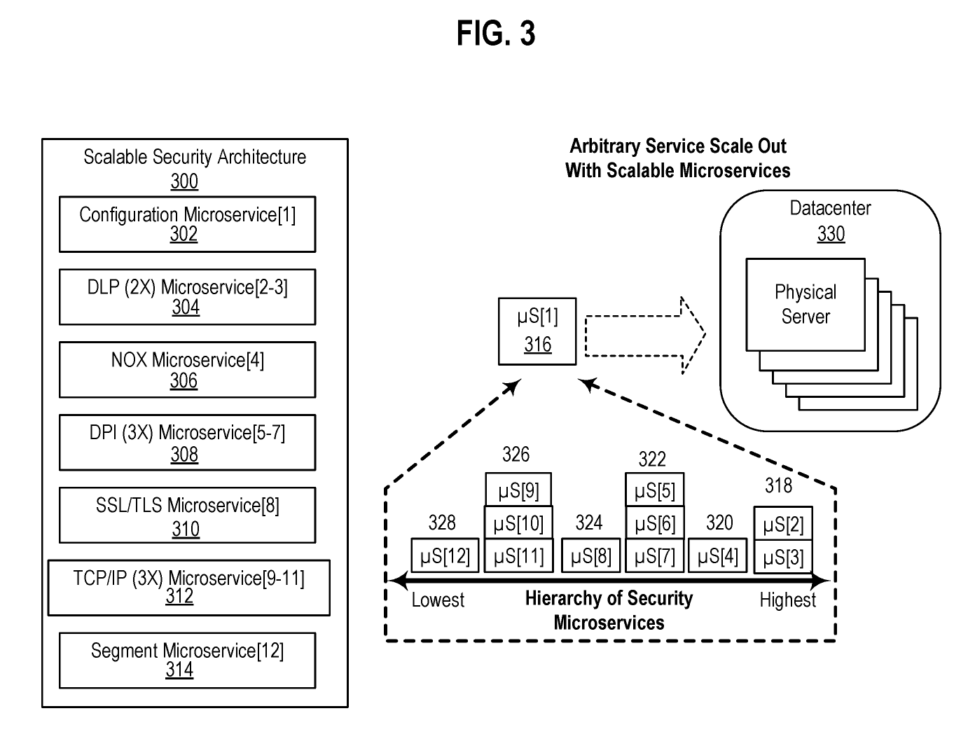

As shown, memory 104 has stored therein microservices 108, 110, 112, 114, 116, 118, 120, and 122 (108-122), as well as a virtual chassis 106, which may also be a microservice. In an embodiment, the microservices are small in size, consisting of a relatively small number of instructions. In an embodiment, the microservices 108-122 are independent of each other. As illustrated, microservices 108-122 are microservices that are loaded from memory and executed by the hardware processor 102. Those microservices 108-122 include data path security microservices, for example TCP/IP, SSL, DPI, or DLP microservices, as described further below with respect to FIGS. 2 and 3. The microservices 108-122 may also include management microservices, for example, a chassis controller to manage the microservices, a configuration microservice, an infrastructure discovery microservice, a database microservice to store data, a policy update microservice to receive policy updates from an external security cloud, and a compiler to receive policy data from various sources and to produce binary policy outputs to be used by the microservices, to name a few examples that are described hereinafter with respect to FIGS. 2 and 3.

Memory 104 also stores security service 124. Security service 124 is configured to utilize a plurality of microservices to detect information from encrypted or obfuscated data packets sent over network connections (e.g., TCP connections) to execute security actions on the data packets transmitted over the network connections. In one embodiment, the embodiments disclosed herein are performed by security service 124. In other embodiments, the embodiments disclosed herein are performed by microservices (e.g., microservices 108-122) based on instructions from security service 124.

It will be understood by those of ordinary skill in the art that a datacenter typically employs many instances of the hardware represented within network security system 100 such as hardware processor 102 and memory 104. Individual servers may have multiple processors or multiple processing boards each with multiple processors. Processors may have a plurality of processing cores and access a plurality of network interfaces. Security service 124 comprises program code executing within a processor and may have interfaces (such as configuration or administration user interfaces) that are made available over a network to users. In a virtualized environment, the user may not be aware of the specific processor on which security service 124 is executing and, in some embodiments, that processor may change based on loading of the virtual environment. Such changes may occur based on administrator requests or automatically based on the virtual environment's control software.

In an embodiment, a network security system 100 receives traffic via network interface 128 to/from a datacenter. In one embodiment, a network security system 100 is placed in-line to inspect traffic, and potentially intercept a threat before it arrives at, or leaves, the datacenter. In other embodiments, a network security system 100 monitors the traffic heading into, or out of, the datacenter, in which case the network security system 100 detects threats and generates alerts, but does not block the data. A hardware processor 102 may execute various data security microservices on the data. For example, as described hereinafter with respect to FIGS. 2 and 3, typically traffic first passes into and through a segment microservice, then a TCP/IP inspection microservice, then a SSL microservice, then a DPI microservice, then a NOX microservice, and then a DLP microservice. However, one or more of these services may not be enabled. In some embodiments, a segment microservice resides within a network segment and serves as the entry point for data packets and forwards the packets to appropriate microservices for further analysis. Data path microservices as used herein refer to various microservices that inspect and analyze network traffic, such as TCP, TLS, DPI, NOX, and DLP microservices. A TCP microservice, for example, refers to a packet handling microservice able to process any layer 4-6 network packet and includes part of firewalling. A TLS microservice, for example, refers to a Transport Layer Security microservice, which decrypts/re-encrypts connections. A DPI microservice, for example, refers to a Deep Packet Inspection microservice and handles layer 7 inspection. A NOX microservice, for example, refers to a Network Object Extractor microservice, and works in conjunction with DPI to assemble objects from individual packets and to deliver the objects to other services. A DLP microservice, for example, refers to a Data Loss Prevention microservice, which detects and attempts to prevent data loss. Control path microservices, on the other hand, are various microservices, such as a factory, a compiler, a configuration, an infrastructure discovery, a database, a messenger, a scaler, and a chassis controller, that are instantiated in, and make up, a management plane. Threats detected by the aforementioned microservices, in one embodiment, are reported to a chassis controller microservice, which takes remedial action.

In an embodiment, microservices 108-122 are implemented using computer-executable instructions loaded from the Internet via network interface 128. For instance, in an embodiment, the microservices are implemented with computer-executable instructions downloaded from a web site or online store site. In some embodiments, microservices 108-122 are loaded into memory 104. In various embodiments, the microservices are implemented using computer-executable instructions loaded on and received from a non-transitory computer-readable medium, such as digital media, including another disc drive, a CD, a CDROM, a DVD, a USB flash drives, a Flash memory, a Secure Digital (SD) memory card, a memory card, without limitation. Microservices received from a digital medium may be stored into memory 104. The embodiments are not limited in this context. In further embodiments, a digital medium is a data source that constitutes a combination of hardware elements such as a processor and memory.

In most embodiments, a network security system 100 runs on a datacenter computer. In other embodiments, however, a network security system 100 is installed and runs on any one of a wide variety of computing platforms, ranging from low-cost to high-cost, and from low-power to high power. In some embodiments, a network security system 100 runs on a server. In some embodiments, a network security system 100 is installed on and runs on a low-cost, commodity server computer, or on a low-cost rack-mounted server. As illustrated, hardware processor 102 is a single core processor. In alternate embodiments, hardware processor 102 is a multi-core processor. In alternate embodiments, hardware processor 102 is a massively parallel processor. In some embodiments, a virtual chassis 106 and microservices 108-122 may be hosted on any of a wide variety of hardware platforms used in the datacenter to be protected.

In some embodiments, a network security system 100 scales out using available resources to accommodate higher traffic or load. In one embodiment, hardware processor 102 (CPU) and memory 104 are scaled out or in dynamically as needed: additional CPUs and memory are added if scaling out, and some CPUs and/or memory are powered down if scaling in. This scaling out is performed to allocate the additional CPUs and memory to those portions of the security hierarchy for which there is demand, while not allocating additional CPUs and memory to those portions of the security hierarchy that can accommodate the higher traffic utilizing their existing allocation.

One property of a microservice is the separation and protection of memory from other microservices. In this manner, an individual microservice may be moved to another physical server or terminate abnormally without impacting other microservices. Microservices may be distinguished from threads in that threads generally operate within a shared memory space and exist within the confines of an operating system on which the microservices were spawned.

FIG. 2 illustrates an example scalable security architecture implementing a three-time scale out using security microservices. In the example of FIG. 2, only a single microservice (e.g., a DPI microservice) has a demand for additional resources. As shown, by utilizing a scalable microservice architecture 200, including DLP microservice 204, NOX microservice 206, DPI microservice 208, SSL/TLS microservice 210, TCP/IP microservice 212, and segment microservice 214, each level of the security service hierarchy can be scaled and configured independently to load balance the supply of processed data to the next hierarchy level. As shown, datacenter 216 includes datacenter rack 218, which includes physical server A 220, physical server B 222, and physical server C 224. As shown, a datacenter rack 226 includes physical server X 228, physical server Y 230, and physical server Z 232. DPI microservices 208 have been scaled out 3×, and in this instance assigned to be performed as microservices 4-to-6 on physical server B 222 and physical server C 224. The remaining microservices of scalable security architecture are shown as being implemented by physical servers A, X, Y, and Z (220, 228, 230, and 232, respectively). A configuration microservice 202 creates a configuration backplane and a data plane deployed as a software component on each physical server that is to receive security services. This process includes configuring routing rules, reserving network address space (such as a subnet), and configuring virtual environments to utilize portions of the reserved address space as gateways for network communication in and out of the servers to be secured. Both the backplane and data plane may thus be considered virtual networks managed by the security system. Security microservices may then utilize these networks to transmit packets, content, state, and other information among the microservices. The properties of the backplane and data plane are configured to reject packet traffic from outside the security system and to route information between microservices regardless of the physical server and virtual environment configuration.

FIG. 3 illustrates an arbitrary scaling out of a microservice according to an embodiment. As shown, scalable security architecture 300 includes configuration microservice 302, DLP (2×) microservice 304 (a 2-times scale-out), NOX microservice 306, DPI (3×) microservice 308 (a 3-times scale-out), SSL/TLS microservice 310, TCP/IP (3×) microservice 312 (a 3-times scale-out), and segment microservice 314. As shown, configuration microservice 316 provisions (318, 320, 322, 324, 326, and 328) the 11 microservices from a lowest hierarchy to a highest hierarchy, and configures them to communicate with each other via a backplane. The microservices, for example, may be implemented by physical servers in datacenter 330.

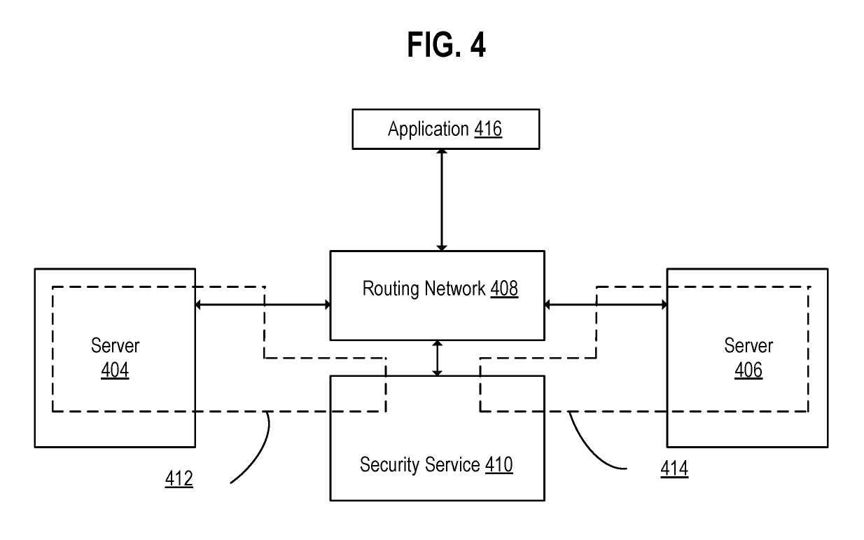

FIG. 4 is a block diagram illustrating a networked computing environment in which an embodiment may be implemented. FIG. 4 represents an example embodiment that is provided for purposes of illustrating a clear example; other embodiments may use different arrangements.

The networked computer system depicted in FIG. 4 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

In one embodiment, one or more security services 410 may be configured to monitor network traffic and other data sent between an application 416 and one or more servers 404, 406 through a routing network 408. The security service 410 comprises one or more “microservices” (e.g., microservices 108-122 in FIG. 1) used to monitor and perform various actions relative to data items (e.g. network traffic, files, email messages, etc.) sent to and received from one or more applications 416 and servers 404, 406. The microservices comprising security service 410 do not need to be confined to one physical server such as a server 404, 406. For example, one or more microservices of the security service 410 may be executed on server 404 and other microservices of the security service 410 are executed on 406. In some embodiments, the security service 410 is executed on a different server from one or more servers for which the security service is responsible for monitoring and protecting. In one embodiment, servers 404, 406, security service 410, and application 416 is deployed in a networked environment. Examples of networked environments include data centers, an on-premise stack, and a set of servers remotely connected using a network.

In an embodiment, a routing network 408 provides connectivity among servers 404, 406, security service 410, and application 416. In some embodiments, routing network 408 is partially configured responsive to hypervisor configuration of servers 404 and 406. In some embodiments, a routing network 408 is partially or entirely configured responsive to hypervisor configuration of servers 404 and/or 406.

In one embodiment, based on routing information included in channel data encapsulation packets, data traveling between an application 416 and server 404 and/or server 406 is routed to the correct server, and is kept separate from data traveling between the application 416 and the other server. Accordingly, what is essentially a private network 412 may be created between the server running security service 410 and server 404. Similarly, what is essentially a private network 414 may be created between the server running security service 410 and server 406.

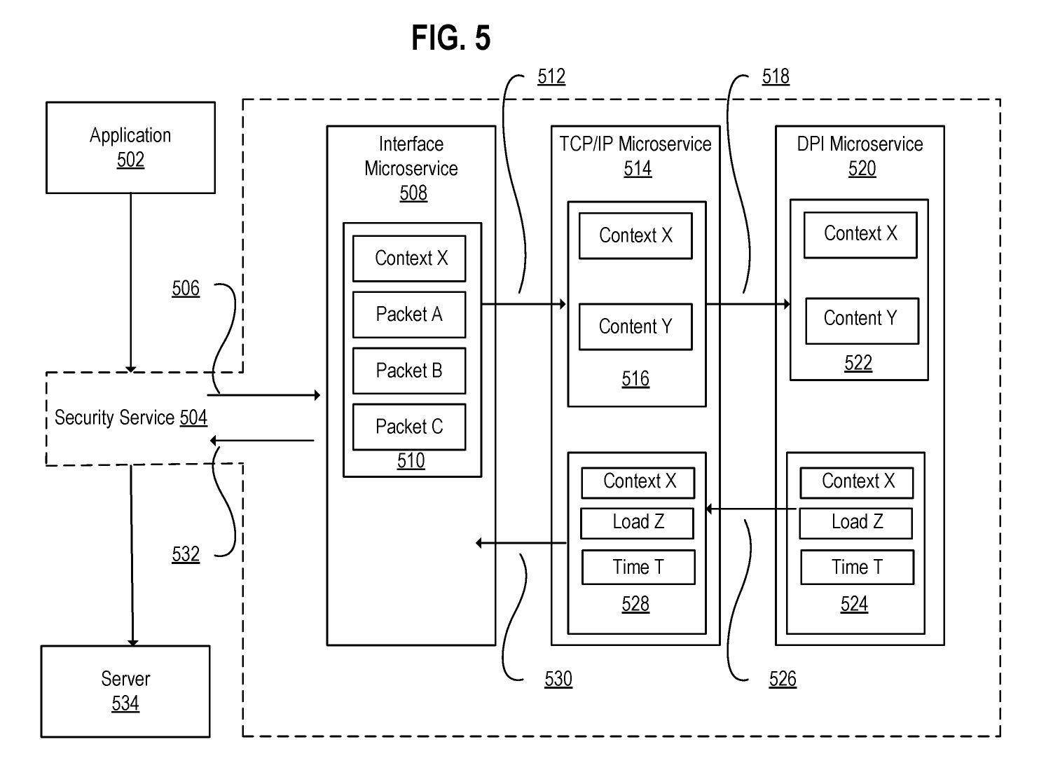

FIG. 5 is a block flow diagram illustrating application data traversing to a server after passing through a hierarchy of security microservices according to an embodiment. As illustrated, the flow begins with security service 504 receiving a network data packet from application 502. Security service 504 forwards 506 the packet to interface microservice 508, which generates a channel data encapsulation packet 510 encapsulating three packets A, B, and C, and a context X. As shown, channel data encapsulation packet 510 encapsulates three packets, but in alternate embodiments, the number of encapsulated packets may vary without limitation. In some embodiments, context X is generated based at least on the headers of packets A, B, and C. In some embodiments, context X is generated based on a lookup of packet header fields such as IP addresses, ports, and MAC addresses for the source and destination of the packets. In some embodiments, the generation of context X includes using an interface identifier obtained from a virtualization environment. Generation of context X may be accomplished through a lookup of header fields and other data in a table, a hash of header fields and other data, or another method whereby packets for which a common security policy is to be applied are associated with a common context or common portion, such as a bit field, of the context.

Context X may be considered an identifier describing the traffic streams, source machines, or applications responsible for generating packets A, B and C. This identifier may be direct (such as an ID used as a table look up), indirect (such as a pointer used to access a data structure), or some other method of instructing microservices as to the policies and processing to use for handling packets A, B, and C. As an example, context X may be generated by performing a hash, longest prefix match, or lookup of header fields such as IP addresses, TCP ports, interface names (or MAC addresses), or other packet properties. The lookup may be an exact match, longest prefix match, or other method to associate packet streams with the same security processing to use. The generated context may then be used by security services, such as a DPI service, to determine which rules to utilize when scanning the data from packets A, B, and C (and other packets that are part of the same traffic stream). This information may be embedded within the context (as a bit field or other information), available by indirection (such as a table or data structure lookup by another service), or generated programmatically based on any combination of such information.

The context may be generated through a look up at an interface microservice and is included in the transmission of packet data to transmission control protocol (TCP) reassembly services. Reassembled content from the TCP microservice is transmitted to a deep packet inspection (DPI) microservice or secure socket layer (SSL) microservice, and with the same context. By maintaining this context in the encapsulation of data transport throughout the microservice hierarchy, processing directives associated with a context become a shared read-only resource (relative to the microservices) and may only rarely use stateful updates.

Interface microservice 508 transmits 512 the channel data encapsulation packet 510 to TCP/IP microservice 514. As shown, the channel data encapsulation packet 516 includes context X and content Y, which corresponds to packets A, B, and C of channel data encapsulation packet 510. After conducting security processing of the channel data encapsulation packet 516, TCP/IP microservice 514 transmits 518 the packet to DPI microservice 520. As shown, the channel data encapsulation packet 522 includes context X and content Y, which corresponds to packets A, B, and C of channel data encapsulation packet 510. After conducting security processing of the channel data encapsulation packet 522, DPI microservice 520 generates channel data encapsulation packet 24, which, as shown, includes context X, DPI load Z, and DPI timestamp T. Encapsulated channel data may be tagged with properties including a timestamp and a load metric. The timestamp may reference the duration of microservice processing, the time at which microservice processing started or another temporal property associated with processing the encapsulated channel data. The load metric may reference the relative or absolute loading of a microservice processing the encapsulated channel data.

As shown, a DPI microservice 520 transmits, via path 526, channel data encapsulation packet 524 to TCP/IP microservice 514, which uses the DPI load and DPI timestamp information to inform future load-balancing decisions. As shown, a TCP/IP microservice 514 generates channel data encapsulation packet 528, which includes context X, TCP/IP load Z, and TCP/IP timestamp T. As shown, TCP/IP microservice 514 transmits, via path 530, channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits the packets to a server 534.

As shown, DPI microservice 520 transmits channel data encapsulation packet 524 to TCP/IP microservice 514, which uses the DPI load and DPI timestamp information to inform future load-balancing decisions. As shown, TCP/IP microservice 514 generates channel data encapsulation packet 528, which includes context X, TCP/IP load Z, and TCP/IP timestamp T. As shown, TCP/IP microservice 514 transmits channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits them to server 534 microservice.

Exemplary benefits of the security service 504 may include the ability of each microservice to utilize the same channel data encapsulation protocol for all communication, thereby allowing scaling across the entirety of the datacenter network routable via the channel data encapsulation header. Communications between microservices maintain a context X generated at interface microservice 508 to all subsequent microservices that no longer have access to the original packets. As an example, a DPI microservice processing content reassembled by a TCP/IP microservice has no visibility into the packets used by the TCP/IP microservice to reassemble the content. However, the context X generated upon reception of one or more of those packets at the interface microservice, forwarded to the TCP/IP microservice and subsequently forwarded by the TCP/IP microservice to the DPI microservice, may be used to determine policy or select a minimal DPI signature set by the DPI microservice without incurring additional state processing. By providing load and timestamp data in the channel data encapsulation packets 524 and 528, which are returned via paths 526 and 530, the microservices receive and can maintain real-time loading and processing latency information utilized to make load balancing decisions.

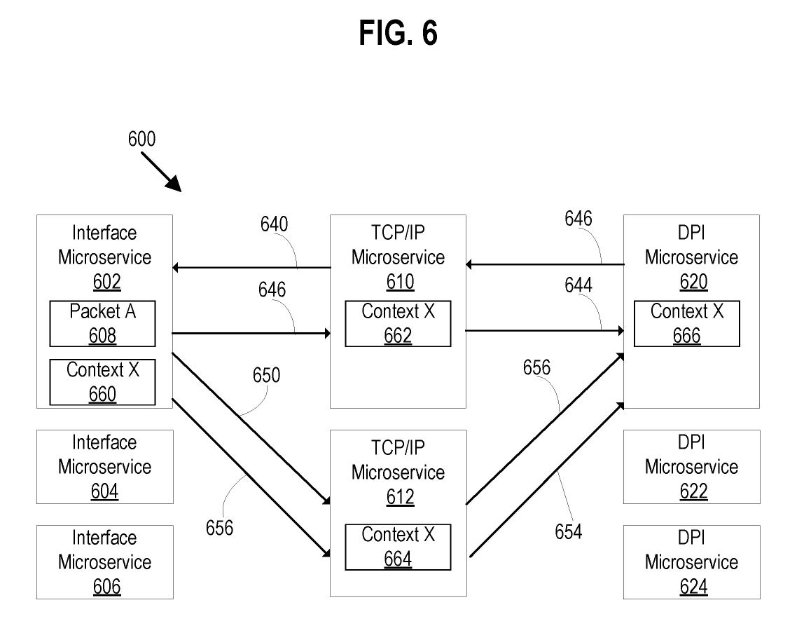

FIG. 6 is a block diagram illustrating a flow of application data through a stateless processing, fault-tolerant microservice environment in accordance with disclosed embodiments. As illustrated, security system 600 includes interface microservices 602, 604, and 606, TCP/IP microservices 610 and 612, and DPI microservices 620, 622, and 624. Other examples include a different number of microservices, different types microservice types, or both. In the example of FIG. 6, an interface microservice 602 receives packet A 608, and generates a context X 660.

One benefit of the security system illustrated in FIG. 6 is the handling of state. For example, if packets belong to a certain context X, the security system 600 may enable both TCP/IP microservices 610 and 612 to perform meaningful work on the packets. By implementing TCP/IP processing as microservices 610 and 612 with an external state structure and a context that accompanies processed data, each TCP/IP microservice, and any other microservice at every level of the security hierarchy, can be isolated from other microservices and can be scaled independently. Each microservice can access the state for any packet or reassembled packet data, thereby enabling real-time load balancing. In many cases, the context enables microservices to forego consulting service state (state associated with processing at the hierarchy level of the specific microservice), thereby reducing the demands on the global state repository.

As an example, consider the context X 662 obtained by TCP/IP microservice 610 as part of packets received from interface microservice 602 as transmission 646. Context X 662, when transmitted to DPI microservice 620 as part of transmission 644, along with the reassembled packet data, contains information that may enable the DPI microservice to forego or simplify processing of this reassembled data. Such information can include, for example, a context bit or field specifying a subset of regular expressions or patterns to be used for DPI processing, a number of bytes of reassembled data to be received before beginning DPI processing, specific allowed or disallowed protocols, and other information potentially avoiding a DPI state lookup.

In an embodiment, microservices of a security system 600 are stateless. For example, each of the microservices may retrieve state information from an outside source such that the microservice can process packets or content belonging to any context. Each microservice may retrieve and update service state (that state associated with the microservice processing). Additionally, each microservice may retrieve and update context state (state associated with the context relevant for all security service processing). In some embodiments, the process state and context state share a global state service. Examples of elements of context state include a level of suspicion regarding traffic from a source IP, a policy to ignore certain ports or protocols, and other information used to process the packets, reassembled content, and extracted objects from communication identified with the context.

In an embodiment, microservices in the same or different hierarchy level of the security system may be able to process packets associated with the same context at the same time. If one security microservice fails (e.g., if a TCP microservice fails to respond to a request), another microservice can take over and process the request using the failed microservice's context.

Returning to FIG. 6, the generation of context X 660 may include considering properties associated with a packet A 608 (e.g., such as an n-tuple detailing routing information), and also a state lookup or a context lookup, in addition to other information. Interface microservice 602 provides packet A 608 and context X 660 to TCP/IP microservice 610 or 612 via path 640 or 650, respectively. For example, interface microservice 602 may conduct a load-balancing to select one of the TCP/IP microservices to forward the packet A 608 and the context X 660.

In an embodiment, TCP/IP microservices 610 and 612 are stateless, but may benefit from the context X generation performed by interface microservice 602. For example, whichever of TCP/IP microservices 610 and 612 receives packet A may disassemble the packet to extract the data associated with the packet and conduct security processing on the data. TCP/IP reassembly generally consists of associating packets with flows (e.g., identified by source and destination IP and port values) and using the TCP sequence numbering to place the packets into a correct order, remove any overlap or duplication, and/or identify missing or out of order packets.

In FIG. 6, TCP/IP microservices 610 or 612 forward the extracted data or the data resulting from the security processing to DPI microservice 620 via paths 644 or 656, respectively. Along with the transmitted data, TCP/IP microservice 610 or 612 forwards context X 662 or 664, respectively, to a DPI microservice 620. In some embodiments, context X 660, 662, 664, and 666 are substantially identical.

In an embodiment, DPI microservice 620 is also stateless and may use the context provided by TCP/IP microservice 610 or 612 in transmission 644 or 656. DPI microservice 620 may load DPI processing state before processing the received data, but can perform some work (e.g., scheduling different DPI pattern state tables) based on the context. Transmitting the context to the DPI microservice therefore may obviate some amount of work by the DPI microservice. If TCP/IP microservice 610 fails and interface microservice 602 instead utilizes TCP/IP microservice 612, DPI microservice 620 may obtain the context from the transmission of reassembled TCP content in transmission 656.

Although FIG. 6 does not show a second packet, when a subsequent packet associated with the same context is received, interface microservice 602 may conduct a load balancing and select one of the TCP/IP microservices to forward the packet along with context X 660. In one embodiment, interface microservice 602 chooses to forward the second packet to TCP/IP microservice 612 via path 650. TCP/IP microservice 612 performs some security processing, then transmits the second packet and context X 664 to DPI microservice 620 via path 654. After performing some security processing, DPI microservice 620 responds to TCP/IP microservice 612 via path 654, and TCP/IP microservice responds to interface microservice 602 via path 656.

Summarizing the operation of an embodiment as illustrated by FIG. 6, an interface microservice transmits packets to a TCP/IP microservice along with a context that has been generated based on the contents of the packets. The transmission comprises a request to perform a security service (e.g., TCP/IP reassembly) for the packets to generate reassembled data. The TCP/IP microservice consults the received context to determine whether to obtain a context state, service state, or both, from a state repository to perform the security service. Reassembly is performed by the TCP/IP microservice, any modified state returned to the state repository and the reassembled data transmitted, along with the context, to a DPI microservice as a request to perform DPI processing.

Continuing the example illustrated by FIG. 6, the DPI microservice receives the reassembled data and context from the request to perform DPI security services transmitted by the TCP/IP microservice. The DPI microservice consults the received context to determine whether to obtain a context state, service state, or both, from a state repository to perform its security service. DPI inspection may be performed by the DPI microservice, any modified state returned to the state repository, and a response sent to the TCP/IP microservice.

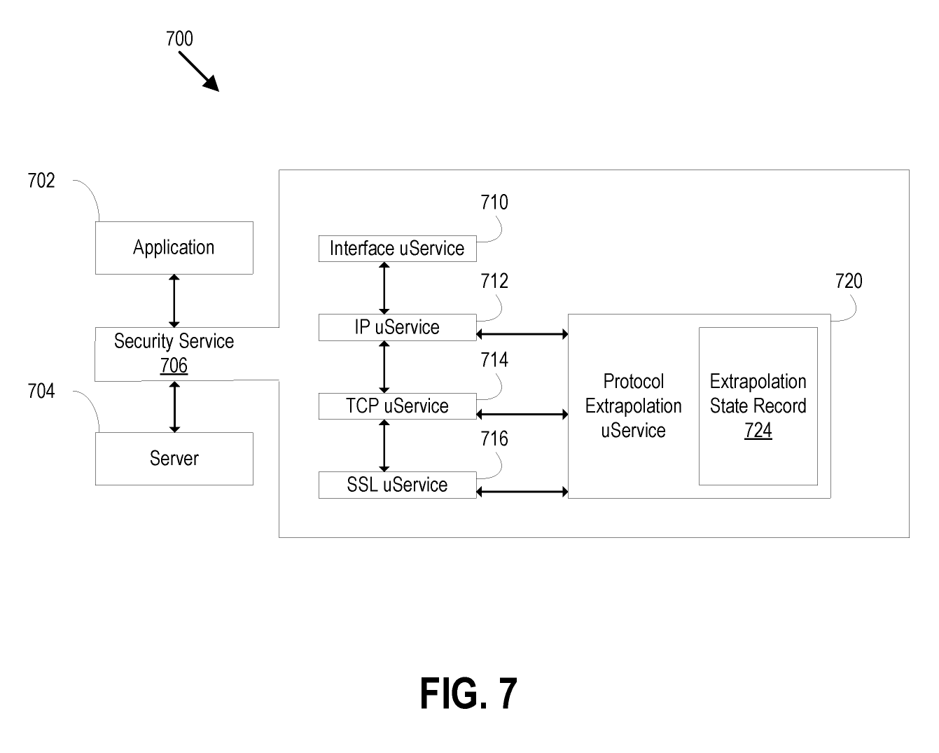

FIG. 7 is a block diagram illustrating a security service in accordance with the disclosed embodiments. In one embodiment, security service 706 is configured to detect encrypted and/or obfuscated protocols and extrapolate the states of the encrypted and/or obfuscated protocols. In one embodiment, security service 706 is an example of security service 124, depicted in FIG. 1. In one embodiment, security service 706 is coupled to one or more applications 702 and a server 704. In one embodiment, security service 706 receives or otherwise intercepts encrypted or obfuscated data packets transmitted between application 702 and server 704.

Security service 706 includes a plurality of microservices, e.g., interface microservice 710, IP microservice 712, TCP microservice 714, and SSL microservice 716. FIG. 7 does not necessarily include all possible microservices, but instead depicts a subset of possible microservices. In one embodiment, the plurality of microservices analyze data frames of an encrypted or obfuscated data packet. In one embodiment, IP microservice 712 is a portion of TCP microservice 714 that deals with IP data frames. In other embodiments, IP microservice 712 is a separate microservice configured to monitor IP forwarding and/or IP security.

In one embodiment, data packets are sent to protocol extrapolation microservice 720. In one embodiment, protocol extrapolation microservice 720 monitors and records elements of state from one or more of the plurality of microservices 710-716 into extrapolation state record 724. In one embodiment, protocol extrapolation microservice 720 analyzes the data retrieved from the plurality of microservices 712-716, and uses data in extrapolation state record 724 to make determinations. For example, using the pattern of traffic over time, protocol extrapolation microservice 720 can detect repeated unsuccessful login attempts, detect a successful login attempt followed by data transference, determine that data is moving in an unexpected direction, etc.

As an example, with reference to FIG. 7, a security service 706 may be configured to analyze encrypted IPSec traffic. The IPSec traffic comprises IP data packets which may be monitored through forwarding from IP microservice 712 to protocol extrapolation microservice 720. A security service 706 may be configured to analyze SSH traffic. The SSH traffic comprises TCP packets which may be monitored through forwarding from TCP microservice 714 to protocol extrapolation service 720. A security microservice 706 may be configured to analyze SSL traffic. The SSL traffic comprises SSL protocol packets which may be monitored through forwarding from SSL microservice 716 to protocol extrapolation service 720.

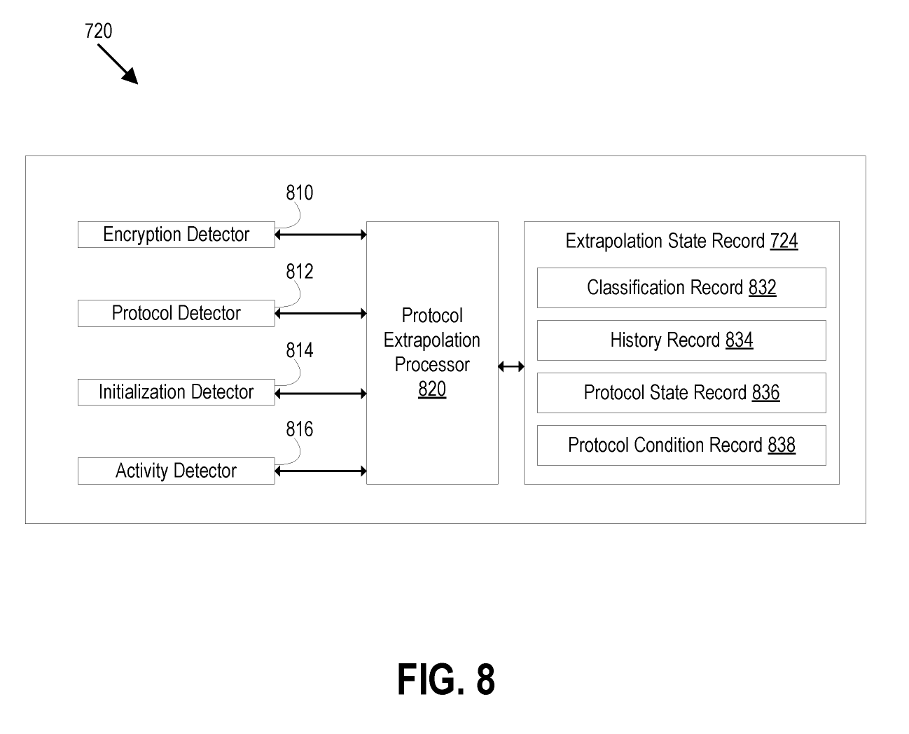

FIG. 8 is a block diagram illustrating protocol extrapolation microservice 720 in accordance with the disclosed embodiments. In the embodiment depicted in FIG. 8, protocol extrapolation microservice 720 includes a plurality of detectors (e.g., encryption detector 810, protocol detector 812, initialization detector 814, and activity detector 816), protocol extrapolation processor 820, and extrapolation state record 724. Extrapolation state record 724 includes classification record 832, history record 834, protocol state record 836, and protocol condition record 838.

Protocol extrapolation processor 820 modifies elements within extrapolation state record 724 using data received from detectors 810-816. In one embodiment, protocol extrapolation microservice 720 makes a determination about the encryption protocol used to encrypt data packets based on extrapolation state record 724.

Encryption detector 810 detects whether a data packet, or series of data packets, is encrypted. For example, encryption detector 810 can detect that that there are no repeated patterns in the bytes representing the data packet and therefore the data packet is likely encrypted. In one embodiment, encryption detector 810 detects that a data packet is encrypted even when it is not able to determine how the data packet was encrypted or how to decrypt the encrypted data packet. In one embodiment, encryption detector 810 provides an indicator or generates a property for a data packet indicating that the data packet is encrypted or not encrypted. Methods of detecting encryption include statistical analysis (such as analyzing histograms of bytes and bytes sequences for flat distributions), signature analysis (such as detecting certain bytes or byte sequences and known offsets), and other methods.

Protocol detector 812 determines an encryption protocol used to encrypt a data packet determined to be encrypted. In one embodiment, protocol detector 812 evaluates data packets to look for signatures associated with different protocols. For examples, protocol detector 812 determines an SSL protocol by identifying or otherwise recognizing an SSL “Hello” message. In another example, protocol detector 812 identifies a protocol based on the particular TCP port being used (e.g., TCP port 22 indicates and SSH protocol).

Initialization detector 814 evaluates data packets of a data transfer at the beginning or initialization of a connection to identify patterns. For example, if the pattern of the data transfer is a short series of bytes, a wait, a short series of return bytes, and another series of bytes back, initialization detector 814 recognizes this as a challenge request/response process or a password entry process.

Activity detector 816 operates similarly to initialization detector 814, but evaluates data packets in the connection over a longer period of time. For example, if activity detector 816 detects a pattern indicating activity on TCP port 22, a short series of bytes, and then a large data transfer in one direction, initialization detector 814 recognizes this as a successful login. In another example, if the pattern of the data transfer is repeated short series of traffic back and forth, activity detector 816 recognizes this as indicating a login process. In another example, if the pattern of the data transfer indicates repeated short series of traffic back and forth followed by a disconnect, activity detector 816 recognizes this as repeated failed login attempts.

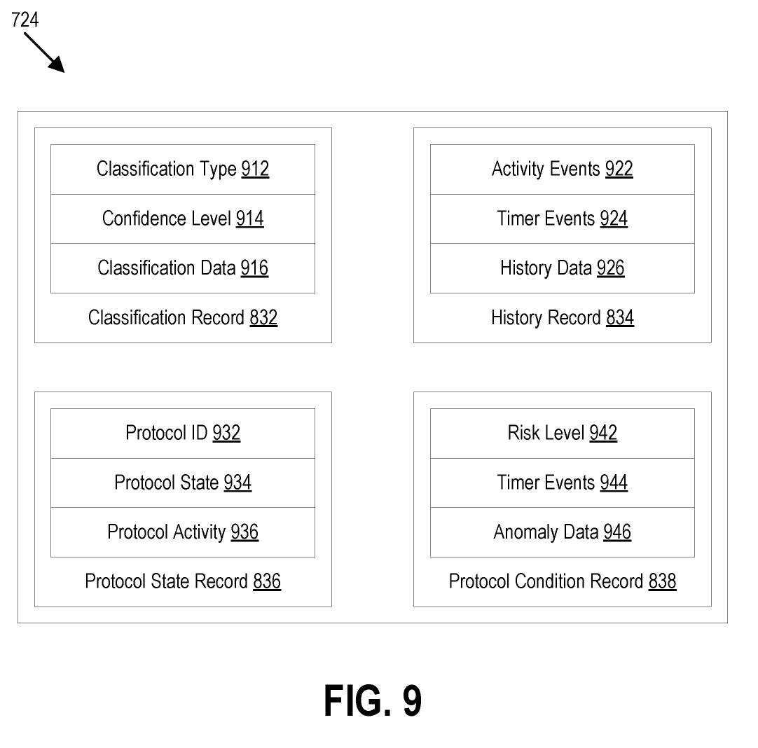

FIG. 9 is a block diagram illustrating extrapolation state record 724 in accordance with the disclosed embodiments. In one embodiment, extrapolation state record 724 includes classification record 832, history record 834, protocol state record 836, and protocol condition record 838. In one embodiment, protocol extrapolation microservice 720 stores records for each flow, or for each flow pair.

Classification record 832 identifies and stores information regarding the encrypted data packet or data stream detected by security service 706 in FIG. 7. Classification record 832 includes classification type 912, confidence level 914, and classification data 916. Examples of classification types stored in classification type 912 include, but are not limited to, SSL, SSH, P2P, FTP, SFTP, etc. The entry in confidence level 914 indicates the level of confidence protocol extrapolation processor 820 has in the classification type indicated in classification type 912. In one embodiment, protocol extrapolation processor 820 may have a low, medium, or high confidence. In other embodiments, confidence level is expressed using a numerical scale. In one embodiment, classification data 916 stores data and information collected by detectors 810-816 used by protocol extrapolation processor 820 to modify classification record 832. In one embodiment,

In an example, protocol extrapolation processor 820 initially determines a classification type for an encrypted data packet based on data from initialization detector 814. In this example, the confidence level of the determined classification type may be initially low and protocol extrapolation processor 820 indicates the “low confidence level” in confidence level 914. Continuing the example, as protocol extrapolation processor 820 receives additional data from detectors 810-816, protocol extrapolation processor 820 may or may not modify the entry indicated in classification type 912, but may modify the confidence level (e.g., from “low” to “medium” or “high”).

History record 834 stores information regarding the encrypted data packet or data stream detected by security service 706 in FIG. 7. In one embodiment, history record 834 store a history of events that were detected by detectors 810-816 and that were used by protocol extrapolation processor 820 to make determinations and modification to extrapolation state record 724. History record 834 includes activity events 922, timer events 924, and history data 926. In one embodiment, in response to activity detector 816 detecting an activity event, protocol extrapolation processor 820 stores information regarding the activity event in history record 834. As activity events may have relevance over time, protocol extrapolation processor 820 also stores information regarding timing of the activity event (e.g., the time the activity event occurred, the length of time the activity event occurred, etc.). For example, history record 834 stores a particular activity event, e.g., an upload followed by a download, and/or time information for the activity event. History data 926 stores the detector records that were relevant or indicative of activity or timer events.

Protocol state record 836 stores a protocol state for the connection. Protocol state record 836 includes protocol ID 932, protocol state 934, and protocol activity 936. Protocol ID 932 stores the identified protocol type (e.g., SSL, SSH, etc.) for the connection. Protocol state 934 stores the protocol state determined for the particular connection. Each type of protocol may have their own unique set of protocol states. These protocol states may be defined by the protocols themselves or established by protocol extrapolation microservices 720. Examples of protocol states for an SSL protocol include pre-key setup, after key setup, administrative, and transferring data. Other protocol states include: login, initialization, data transfer, repeated login, etc. Using the information received from detectors 810-816, protocol extrapolation processor 820 classifies the connection as being in a particular protocol state. Protocol activity 936 stores the detector record that had information used by protocol extrapolation processor 820 to determine the particular protocol state.

Protocol condition record 838 stores additional information regarding a protocol determined the detector records for detectors 810-816. Protocol condition record 838 includes risk level 942, timer events 944, and anomaly data 946. In one embodiment, protocol condition record 838 stores information about a protocol or activity of a protocol that indicates anything anomalous and/or that could be relevant to security. For example, protocol condition record 838 may store information indicating that a user is repeatedly attempting to login. Risk level 942 stores a risk level that can be adjusted based on the detector records. In one embodiment, the risk level is set at a default level and increased or decreased based on detector records. In one embodiment, when the risk level reaches a predetermined threshold level, a security action is performed. For example, an alert or notification message may be initiated. In one embodiment, the security action includes blocking the encrypted data packet, blocking the connection on which the encrypted data packet is being transmitted from sending further data packets, and/or quarantining the encrypted data packet. Anomaly data 946 stores the detector record that had information used by protocol extrapolation processor 820 to modify the risk level, and timer events 944 includes time information for the detector record.

In one embodiment, detector records from detectors 810-816 are used to effect one or more of classification record 832, history record 834, protocol state record 836, and protocol condition record 838. For example, when activity detector 816 detects a login activity event, protocol extrapolation processor 820 modifies history record 834 by storing a login activity event in activity event 922, the time of the login in timer events 924, and the activity detector record in history data 926. When activity detector 816 detects a second login activity event occurring within a short period of time (e.g., two seconds later), because history record 834 includes the first login activity event, protocol extrapolation processor 820 determines two login attempts occurred within the short period of time. In response, protocol extrapolation processor 820 modifies protocol condition record 838 by increasing the risk level in risk level 942, stores the time of the anomalous activity event (e.g., the second login) in timer events 944, and stores the activity detector record in anomaly data 946. In one embodiment, where the risk level is increased above a predetermined risk level, security service 706 performs a security action.

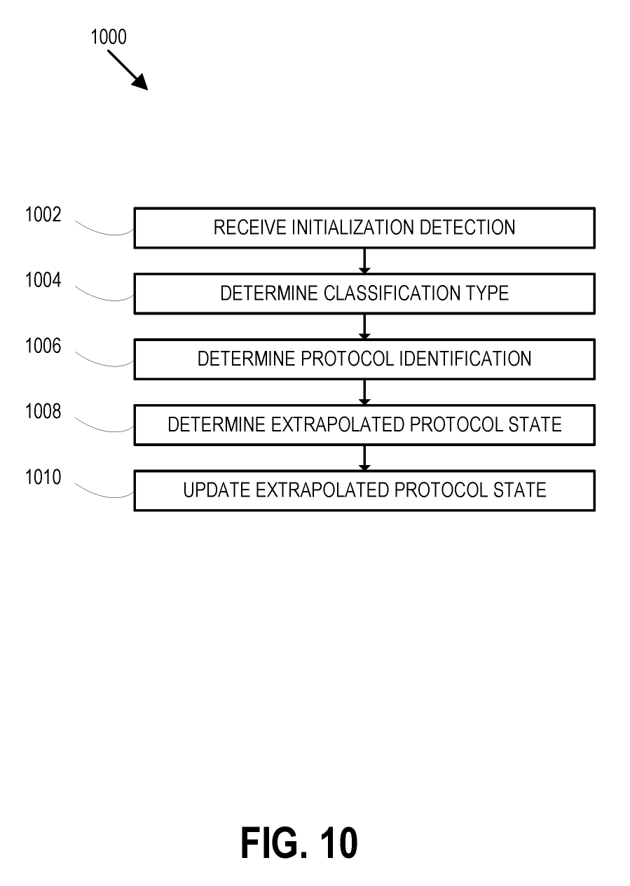

FIG. 10 is a flow diagram illustrating a process for determining an extrapolated protocol state for an encrypted or obfuscated protocol in accordance with an embodiment. For ease of understanding, the description of FIG. 10 below references components of the networked environment of FIGS. 1 and 7-9, however, it is not limited to those components. In one embodiment, the actions below are performed using a security service (e.g., 124 in FIG. 1). In another embodiment, protocol extrapolation processor 820 receives instructions from security service 706 to perform the actions below. Further, the actions below may be performed by one or more security microservices and/or one or more interface microservices. As such, a single security microservice may perform an action, or two more security services may perform the action either independently, or in conjunction.

At block 1002, protocol extrapolation processor 820 receives initialization detection from initialization detector 814. For example, initialization detector 814 sends information to protocol extrapolation processor 820 indicating that data traffic has been initiated. Initiation of data traffic may be identified based on detecting the establishment of a connection, an initial flow of bytes, the first packet transmitted for a period of time, etc.

At block 1004, protocol extrapolation processor 820 determines a classification type for the encryption protocol used for the data packet. In one embodiment, protocol extrapolation processor 820 makes the determination of the classification type based on a detected activity detected by one or more detectors 810-816, including the determined activity received from initialization detector 814. For example, protocol extrapolation processor 820 can determine the classification type based on the port used for the connection, including using the history of previous connections using the same port. In one embodiment, protocol extrapolation processor 820 stores the determined classification type in classification type 912 in classification record 832.

At block 1006, protocol extrapolation processor 820 determines a protocol identification. Examples of protocol identifications include, but are not limited to: file transfer, peer-to-peer, SSL, SSH, etc. In one embodiment, the determination of the protocol identification is based on matching the information received from detectors 810-816 with established models for different types of connections. In one embodiment, protocol extrapolation processor 820 stores the determined protocol identification in protocol ID 932 in protocol state record 836.

At block 1008, protocol extrapolation processor 820 determines an extrapolated protocol state. In one embodiment, the extrapolated protocol states are based on the actual protocol states for a particular protocol. In one embodiment, the extrapolated protocol states are a defined subset of the actual protocol states, where a plurality of actual protocol states are combined into a single extrapolated protocol state. For example, the extrapolated protocol states for an FTP protocol may be defined by security service 706 as: initializing, listing, and transferring, whereas the actual protocol states for the FTP protocol includes many more protocol states.

In one embodiment, protocol extrapolation processor 820 determines the extrapolated protocol state by evaluating the information received from detectors 810-816. In one embodiment, protocol extrapolation processor 820 stores the determined extrapolated protocol state in protocol state 934 in protocol state record 836.

At block 1010, protocol extrapolation processor 820 updates the extrapolated protocol state. In one embodiment, as protocol extrapolation processor 820 receives additional information from one or more of detectors 810-816, protocol extrapolation processor 820 updates the extrapolated protocol state stored in protocol state 934 in protocol state record 836. In one example, protocol state record 836 may comprise states such as “idle”, “uploading” and “downloading” for protocol state 934 based on determining whether the recent observed activity is consistent with no bulk traffic, bulk traffic from initiator to target or bulk traffic from target to initiator, respectively. In this example, initiator and target may be viewed in terms of the initiator of the traffic (such as first observation of the traffic by a security system between IP pairs) and that initiator's target, and bulk traffic may be viewed in terms of achieving a threshold level of bytes per second of transferred data. Protocol extrapolation processor 820 may update protocol state 934 from “idle” to “uploading” if a large number of packets are observed from the initiator to the target after a time of no traffic.

Updating protocol state 934 may impact security policy processing within security service 706. In one embodiment, the duration a connection may spend in an extrapolated idle state is limited. Such an embodiment may infer that connections with little data transfer over a prolonged period of time are higher security risks than connections which are established, transfer bulk data and then torn down. In accordance with the advantages provided by the present invention, such determinations may be made without visibility into the encrypted or obfuscated data. In one embodiment, in response to the updated protocol state, protocol extrapolation processor 820 executes a security action (e.g., block traffic, close connection, block connection, etc.), or instructs security service 706 to perform the security action.

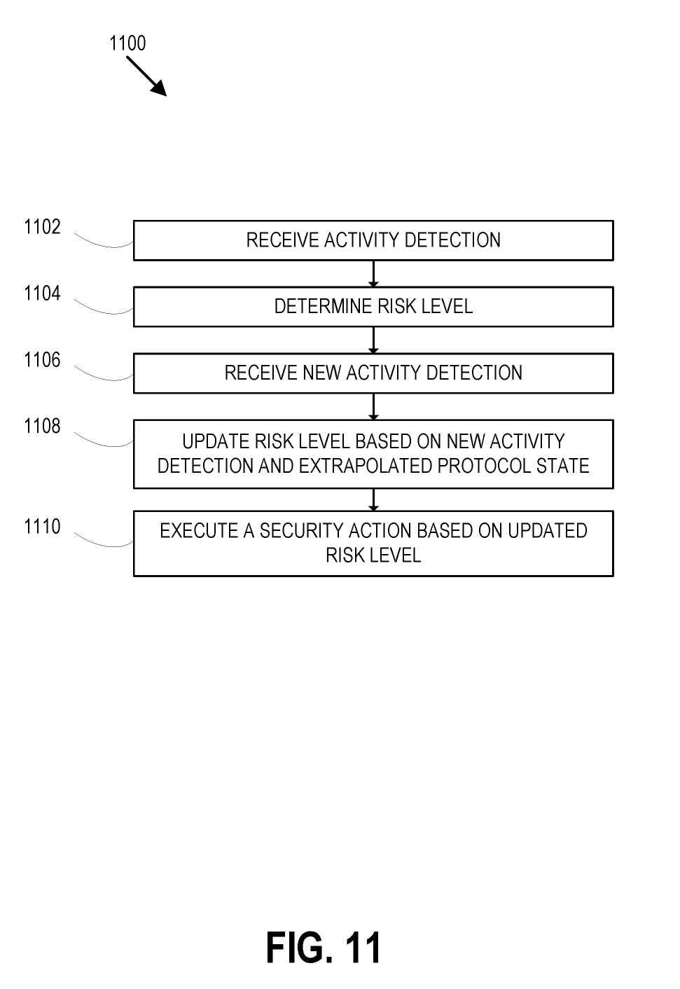

FIG. 11 is a flow diagram illustrating a process for executing a security action based on updating a risk level in accordance with an embodiment. For ease of understanding, the description of FIG. 11 below references components of the networked environment of FIGS. 1 and 7-9, however, it is not limited to those components. In one embodiment, the actions below are performed using a security service (e.g., 124 in FIG. 1). In another embodiment, protocol extrapolation processor 820 receives instructions from security service 706 to perform the actions below. Further, the actions below may be performed by one or more security microservices and/or one or more interface microservices. As such, a single security microservice may perform an action, or two more security services may perform the action either independently, or in conjunction.

At block 1102, protocol extrapolation processor 820 receives an activity detection from one or more of detectors 810-816. At block 1104, protocol extrapolation processor 820 determines a risk level for the encrypted data flow or connection. In one embodiment, the risk level for the encrypted connection is set at a default level. For example, where the risk level is a numeric scale, the default risk level can be set to 0. In another example, the risk level is set at “no risk” or “low risk.” Based on the received activity from activity detector 816, protocol extrapolation processor 820 determines whether the activity event detected by activity detector 816 is indicative of an event that effects the risk level. Where the activity event is one that is considered to have some risk or high risk, protocol extrapolation processor 820 increases the risk level by increasing the numeric value or, alternatively, setting the risk level to “medium risk.” For example, if the received activity detection from activity detector 816 indicates repeated failed login attempts, protocol extrapolation processor 820 recognizes this as indicative of some risk.

In one embodiment, protocol extrapolation processor 820 access protocol state 934 to determine the current extrapolated protocol states. In such embodiment, protocol extrapolation processor 820 uses the extrapolated protocol state and the detected activity received from detectors 810-816 to determine the risk level.

At block 1106, protocol extrapolation processor 820 receives a new activity detection from one or more of detectors 810-816. At block 1108, protocol extrapolation processor 820 updates a risk level based on the new activity detection and an extrapolated protocol state for the network connection. In one embodiment, protocol extrapolation processor 820 accesses history record 834 to retrieve the history of activity events 922 and timer events 924. Protocol extrapolation processor 820 uses the extrapolated protocol state and the history of the activity and the new activity to update the risk level in risk level 942. For example, if the new activity is anomalous (e.g., not expected in the current extrapolated protocol state), protocol extrapolation processor 820 increases the risk level associated with the encrypted connection. Conversely, if the new activity is not anomalous, protocol extrapolation processor 820 maintains or decreases the risk level associated with the encrypted connection.

In one example, protocol condition record 838 may comprise risk levels such as “low”, “medium” and “high” for risk level 942 determining whether the recent observed activity is consistent with different degrees of risk posed by a target to an initiator as defined by the configuration of the security system. In this example, initiator and target may be viewed in terms of the initiator of the traffic (such as first observation of the traffic by a security system between IP pairs) and target of that initiator's traffic. Protocol extrapolation processor 820 may update risk level 838 from “low” to “medium” if history record 834 is indicative of a deviation from commonly observed protocol behavior, anomalous behavior (such as periodic bulk data transfers to a target, multiple connection attempts to a target or other behavior), or other policy or behavior-based observation.

At block 1110, protocol extrapolation processor 820 executes a security action based on the updated risk level. In one embodiment, the security action is one or more of generating an alert or notification message, blocking the data flow on the network connection and/or quarantining the data flow on the network connection. In one embodiment, the security action is executed in response to determining that the updated risk level is above a predetermined risk threshold value.

According to one embodiment, the techniques described herein are implemented by one or more special-purpose computing devices. The special-purpose computing devices may be desktop computer systems, portable computer systems, handheld devices, networking devices or any other device that incorporates hard-wired, program logic, or both to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

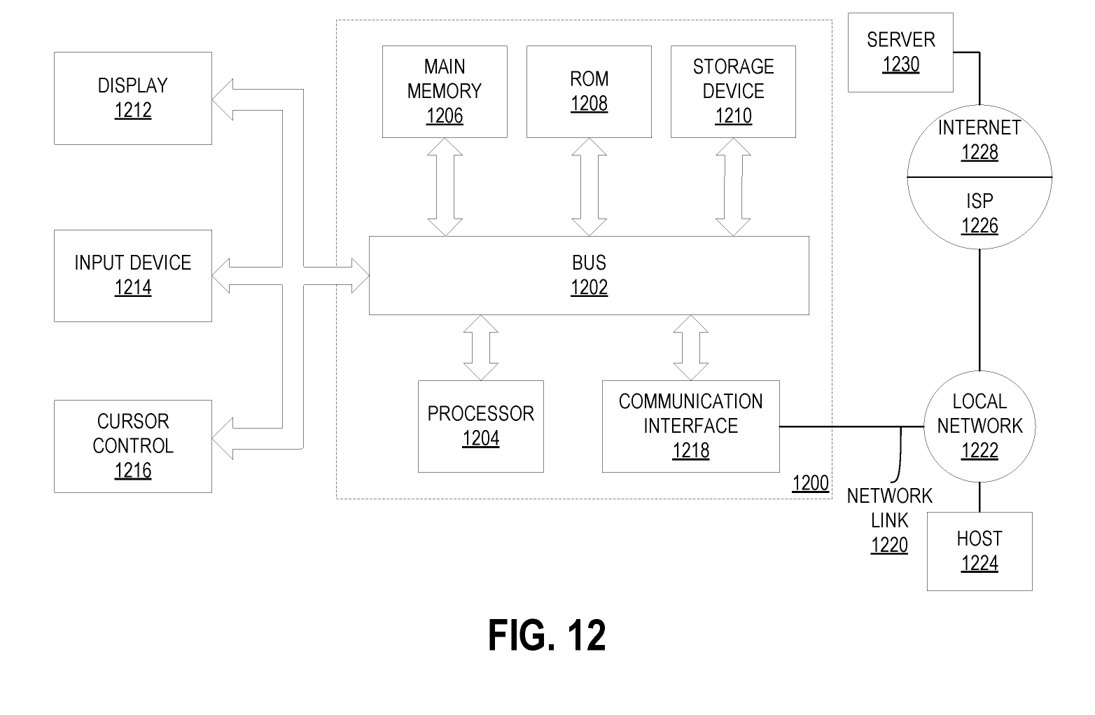

FIG. 12 is a block diagram that illustrates a computer system 1200 utilized in implementing the above-described techniques in accordance with some of the disclosed embodiments. Computer system 1200 may be, for example, a desktop computing device, laptop computing device, tablet, smartphone, server appliance, computing mainframe, multimedia device, handheld device, networking apparatus, or any other suitable device.

Computer system 1200 includes one or more buses 1202 or other communication mechanism for communicating information, and one or more hardware processors 1204 coupled with buses 1202 for processing information. Hardware processors 1204 may be, for example, general purpose microprocessors. Buses 1202 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1200 also includes a main memory 1206, such as a random access memory (RAM) or other dynamic or volatile storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 a special-purpose machine that is customized to perform the operations specified in the instructions.

Computer system 1200 further includes one or more read only memories (ROM) 1208 or other static storage devices coupled to bus 1202 for storing static information and instructions for processor 1204. One or more storage devices 1210, such as a solid-state drive (SSD), magnetic disk, optical disk, or other suitable non-volatile storage device, is provided and coupled to bus 1202 for storing information and instructions.

Computer system 1200 may be coupled via bus 1202 to one or more displays 1212 for presenting information to a computer user. For instance, computer system 1200 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1212 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 1212.

One or more input devices 1214 are coupled to bus 1202 for communicating information and command selections to processor 1204. One example of an input device 1214 is a keyboard, including alphanumeric and other keys. Another type of user input device 1214 is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. Yet other examples of suitable input devices 1214 include a touch-screen panel affixed to a display 1212, cameras, microphones, accelerometers, motion detectors, and/or other sensors. In an embodiment, a network-based input device 1214 may be utilized. In such an embodiment, user input and/or other information or commands may be relayed via routers and/or switches on a Local Area Network (LAN) or other suitable shared network, or via a peer-to-peer network, from the input device 1214 to a network link 1220 on the computer system 1200.

A computer system 1200 may implement techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or a solid state drive of a remote computer. The remote computer can load the instructions into its dynamic memory and use a modem to send the instructions over a network, such as a cable network or cellular network, as modulate signals. A modem local to computer system 1200 can receive the data on the network and demodulate the signal to decode the transmitted instructions. Appropriate circuitry can then place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

A computer system 1200 may also include, in an embodiment, one or more communication interfaces 1218 coupled to bus 1202. A communication interface 1218 provides a data communication coupling, typically two-way, to a network link 1220 that is connected to a local network 1222. For example, a communication interface 1218 may be an integrated services digital network (ISDN) card, cable modem, satellite modem, or a modem to provide a data communication connection to a corresponding type of telephone line. As another example, the one or more communication interfaces 1218 may include a local area network (LAN) card to provide a data communication connection to a compatible LAN. As yet another example, the one or more communication interfaces 1218 may include a wireless network interface controller, such as an 802.11-based controller, Bluetooth controller, Long Term Evolution (LTE) modem, and/or other types of wireless interfaces. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by a Service Provider 1226. Service Provider 1226, which may for example be an Internet Service Provider (ISP), in turn provides data communication services through a wide area network, such as the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

In an embodiment, computer system 1200 can send messages and receive data, including program code and/or other types of instructions, through the network(s), network link 1220, and communication interface 1218. In the Internet example, a server 1230 might transmit a requested code for an application program through Internet 1228, ISP 1226, local network 1222 and communication interface 1218. The received code may be executed by processor 1204 as it is received, and/or stored in storage device 1210, or other non-volatile storage for later execution. As another example, information received via a network link 1220 may be interpreted and/or processed by a software component of the computer system 1200, such as a web browser, application, or server, which in turn issues instructions based thereon to a processor 1204, possibly via an operating system and/or other intermediate layers of software components.

In an embodiment, some or all of the systems described herein may be or comprise server computer systems, including one or more computer systems 1200 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer-readable storage medium, storing software instructions, which when executed by one or more processors cause performance of any of the foregoing methods.

Although some embodiments disclosed herein involve data handling and distribution in the context of hardware execution units and logic circuits, other embodiments can be accomplished by way of a data or instructions stored on a non-transitory machine-readable, tangible medium, which, when performed by a machine, cause the machine to perform functions consistent with at least one embodiment. In one embodiment, functions associated with embodiments of the present disclosure are embodied in computer-executable instructions. The instructions can be used to cause a general-purpose or special-purpose hardware processor that is programmed with the instructions to perform the steps of the at least one embodiment. Embodiments of the present invention may be provided as a computer program product or software which may include a machine or computer-readable medium having stored thereon instructions which may be used to program a computer (or other electronic devices) to perform one or more operations according to the at least one embodiment. Alternatively, steps of embodiments may be performed by specific hardware components that contain fixed-function logic for performing the steps, or by any combination of programmed computer components and fixed-function hardware components.

Instructions used to program circuits to perform at least one embodiment can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Examples of embodiments of methods, apparatuses, systems, etc. detailed herein are listed below.

In some embodiments, a computer-implemented method comprises: receiving an activity detection from a detector configured to monitor data traffic transmitted over a connection; determining a risk level associated with the connection; receiving a new activity detection; updating the risk level associated with the connection based on the new activity detection and an extrapolated protocol state; and executing a security action on the connection based on the updated risk level.

In some embodiments, one or more of the following applies: 1) executing the security action includes performing one or more of: blocking data traffic on the connection, quarantining the data traffic, and transmitting an alert message; 2) the connection is encrypted using an encryption protocol; and 3) updating the risk level associated with the connection based on the new activity detection and the extrapolated protocol state comprises: increasing the risk level associated with the connection in response to determining that an activity event indicated in the new activity detection is anomalous.

In some embodiments, one or more non-transitory computer-readable storage media store instructions which, when executed by one or more hardware processors, cause performance of a method comprising: receiving an activity detection from a detector configured to monitor data traffic transmitted over a connection; determining a risk level associated with the connection; receiving a new activity detection; updating the risk level associated with the connection based on the new activity detection and an extrapolated protocol state; and executing a security action on the connection based on the updated risk level.

In some embodiments, one or more of the following applies: 1) executing the security action includes performing one or more of: blocking data traffic on the connection, quarantining the data traffic, and transmitting an alert message; 2) the connection is encrypted using an encryption protocol; and 3) updating the risk level associated with the connection based on the new activity detection and the extrapolated protocol state comprises: increasing the risk level associated with the connection in response to determining that an activity event indicated in the new activity detection is anomalous.

In some embodiments, an apparatus comprises: one or more hardware processors; and memory coupled to the one or more hardware processors, the memory storing instructions which, when executed by the one or more hardware processors, cause the apparatus to: receive an activity detection from a detector configured to monitor data traffic transmitted over a connection; determine a risk level associated with the connection; receive a new activity detection; update the risk level associated with the connection based on the new activity detection and an extrapolated protocol state; and execute a security action on the connection based on the updated risk level.

In some embodiments, one or more of the following applies: 1) executing the security action includes performing one or more of: blocking data traffic on the connection, quarantining the data traffic, and transmitting an alert message; 2) the connection is encrypted using an encryption protocol; and 3) updating the risk level associated with the connection based on the new activity detection and the extrapolated protocol state comprises: increasing the risk level associated with the connection in response to determining that an activity event indicated in the new activity detection is anomalous.

In some embodiments, a computer-implemented method comprises: receiving an initialization detection from an initialization detector monitoring an encrypted connection; determining a classification type for an encryption protocol used on the encrypted connection; determining a protocol identification for the encryption protocol; determining an extrapolated protocol state for the encryption protocol; and updating the extrapolated protocol state in response to receiving additional detections from the detectors.

In some embodiments, one or more of the following applies: 1) the extrapolated protocol state for the encrypted connection is determined using information received from one or more detectors analyzing characteristics of the encrypted connection; and 2) the method further comprises: executing a security action on the encrypted connection in response to the updated extrapolated protocol state.

In some embodiments, one or more non-transitory computer-readable storage media store instructions which, when executed by one or more hardware processors, cause performance of a method comprising: receiving an initialization detection from an initialization detector monitoring an encrypted connection; determining a classification type for an encryption protocol used on the encrypted connection; determining a protocol identification for the encryption protocol; determining an extrapolated protocol state for the encryption protocol; and updating the extrapolated protocol state in response to receiving additional detections from the detectors.

In some embodiments, one or more of the following applies: 1) the extrapolated protocol state for the encrypted connection is determined using information received from one or more detectors analyzing characteristics of the encrypted connection; and 2) the method further comprises: executing a security action on the encrypted connection in response to the updated extrapolated protocol state.

In some embodiments, an apparatus comprises: one or more hardware processors; and memory coupled to the one or more hardware processors, the memory storing instructions which, when executed by the one or more hardware processors, cause the apparatus to: receive an initialization detection from an initialization detector monitoring an encrypted connection; determine a classification type for an encryption protocol used on the encrypted connection; determine a protocol identification for the encryption protocol; determine an extrapolated protocol state for the encryption protocol; and update the extrapolated protocol state in response to receiving additional detections from the detectors

In some embodiments, one or more of the following applies: 1) the extrapolated protocol state for the encrypted connection is determined using information received from one or more detectors analyzing characteristics of the encrypted connection; and 2) the instructions further cause the apparatus to: execute a security action on the encrypted connection in response to the updated extrapolated protocol state.

What is claimed is:

1. A computer-implemented method comprising:
receiving an activity detection from a detector configured to monitor data traffic transmitted over a connection;
determining a risk level associated with the connection;
receiving a new activity detection;
updating the risk level associated with the connection based on the new activity detection and an extrapolated protocol state; and
executing a security action on the connection based on the updated risk level.

2. The computer-implemented method of claim 1, wherein executing the security action includes performing one or more of: blocking data traffic on the connection, quarantining the data traffic, and transmitting an alert message.

3. The computer-implemented method of claim 1, wherein the connection is encrypted using an encryption protocol.

4. The computer-implemented method of claim 1, wherein updating the risk level associated with the connection based on the new activity detection and the extrapolated protocol state comprises:
increasing the risk level associated with the connection in response to determining that an activity event indicated in the new activity detection is anomalous.

5. One or more non-transitory computer-readable storage media storing instructions which, when executed by one or more hardware processors, cause performance of a method comprising:
receiving an activity detection from a detector configured to monitor data traffic transmitted over a connection;
determining a risk level associated with the connection;
receiving a new activity detection;
updating the risk level associated with the connection based on the new activity detection and an extrapolated protocol state; and
executing a security action on the connection based on the updated risk level.

6. The one or more non-transitory computer-readable storage media of claim 5, wherein executing the security action includes performing one or more of: blocking data traffic on the connection, quarantining the data traffic, and transmitting an alert message.

7. The one or more non-transitory computer-readable storage media of claim 5, wherein the connection is encrypted using an encryption protocol.

8. The one or more non-transitory computer-readable storage media of claim 5, wherein updating the risk level associated with the connection based on the new activity detection and the extrapolated protocol state comprises:
increasing the risk level associated with the connection in response to determining that an activity event indicated in the new activity detection is anomalous.

9. An apparatus comprising:
one or more hardware processors;
memory coupled to the one or more hardware processors, the memory storing instructions which, when executed by the one or more hardware processors, causes the apparatus to:
receive an activity detection from a detector configured to monitor data traffic transmitted over a connection;
determine a risk level associated with the connection;
receive a new activity detection;
update the risk level associated with the connection based on the new activity detection and an extrapolated protocol state; and
execute a security action on the connection based on the updated risk level.

10. The apparatus of claim 9, wherein executing the security action includes performing one or more of: blocking data traffic on the connection, quarantining the data traffic, and transmitting an alert message.

11. The apparatus of claim 9, wherein the connection is encrypted using an encryption protocol.

12. The apparatus of claim 9, wherein updating the risk level associated with the connection based on the new activity detection and the extrapolated protocol state comprises:
increasing the risk level associated with the connection in response to determining that an activity event indicated in the new activity detection is anomalous.

13. A computer-implemented method comprising:
receiving an initialization detection from an initialization detector monitoring an encrypted connection;
determining a classification type for an encryption protocol used on the encrypted connection;
determining a protocol identification for the encryption protocol;
determining an extrapolated protocol state for the encryption protocol; and
updating the extrapolated protocol state in response to receiving additional detections from the detectors.

14. The computer-implemented method of claim 1, wherein the extrapolated protocol state for the encrypted connection is determined using information received from one or more detectors analyzing characteristics of the encrypted connection.

15. The computer-implemented method of claim 1, further comprising:
executing a security action on the encrypted connection in response to the updated extrapolated protocol state.

16. One or more non-transitory computer-readable storage media storing instructions which, when executed by one or more hardware processors, cause performance of a method comprising:
receiving an initialization detection from an initialization detector monitoring an encrypted connection;
determining a classification type for an encryption protocol used on the encrypted connection;
determining a protocol identification for the encryption protocol;
determining an extrapolated protocol state for the encryption protocol; and
updating the extrapolated protocol state in response to receiving additional detections from the detectors.

17. The one or more non-transitory computer-readable storage media of claim 16, wherein the extrapolated protocol state for the encrypted connection is determined using information received from one or more detectors analyzing characteristics of the encrypted connection:

18. The one or more non-transitory computer-readable storage media of claim 16, further comprising:
executing a security action on the encrypted connection in response to the updated extrapolated protocol state.

19. An apparatus comprising:
one or more hardware processors;
memory coupled to the one or more hardware processors, the memory storing instructions which, when executed by the one or more hardware processors, causes the apparatus to:
receive an initialization detection from an initialization detector monitoring an encrypted connection;
determine a classification type for an encryption protocol used on the encrypted connection;
determine a protocol identification for the encryption protocol;
determine an extrapolated protocol state for the encryption protocol; and
update the extrapolated protocol state in response to receiving additional detections from the detectors.

20. The apparatus of claim 19, wherein the extrapolated protocol state for the encrypted connection is determined using information received from one or more detectors analyzing characteristics of the encrypted connection.

21. The apparatus of claim 19, further comprising:
executing a security action on the encrypted connection in response to the updated extrapolated protocol state.
